(19) United States
(12) Patent Application Publication
(10) Pub. No.: US 2011/0129808 A1
(43) Pub. Date: Jun. 2, 2011

(54) Self-Managed Intelligent Learning System

(76) Inventor: Sandeep Srivastava, New Delhi (IN)

(21) Appl. No.: 12/995,072

(22) PCT Filed: May 29, 2009
(86) PCT No.: PCT/IN2009/000311

§ 371 Date: Feb. 16, 2011

(30) Foreign Application Priority Data
May 30, 2008 (IN) 1315/DEL/08
Aug. 22, 2008 (IN) 1997/DEL/08

(51) Int. Cl. G09B 7/00

(52) U.S. Cl. 434/322

(57) ABSTRACT

The present invention relates to a 360° learning system wherein the system is creating the next-generation education system, a self-managed learning ecosystem, a personalized learning context for each learner, by enabling a uniquely integrated and comprehensive digital content and process platform that has 360° span of association with respect to individual users, institutional users, domain, enablements, access, benefits and hardware (including a dedicated ‘PDA’ optimized for learning purposes to be an optional access device for students).

The present application incorporates the disclosures of two cognate provisional patent application Nos. 1315/DEL/2008 filed on May 30, 2008 and 1997/DEL/2008 filed on Aug. 22, 2008 and claims priority therefrom.

### FIELD OF INVENTION

The present invention relates, in general, to the field of education. The system particularly relates to the field of ‘e-led learning’. This invention relates to an independent learning system in the larger field of education or self-tutoring and self-coaching platform for education. It also aims to build a more effective Personal Digital Assistant (PDA) for learning purposes and calls it Personal Learning Assistant (PLA). The PLA will help strengthen the personalization of learning context on a more secure digital platform.

### DESCRIPTION OF THE RELATED ART

Education is a very personnel-intensive domain. The eye contact, body language, verbal explanations, copy checking, sketches on the blackboard, counseling etc. are all very integral to the process of instruction and learning. In fact, all interventions to improve the quality of education have centered around the quality of time and knowledge of the teachers. All the educational portals, including I.T.-based home schooling, have also factored significant role of the actual physical context/neighbourhood of the learners—teachers, ‘caring adults’, tutors, student peers—in ensuring quality learning gains of the students.

At another plane, the education ecosystem has grown to encompass the mainstream education provider—the schools and a host of ‘supplementary education providers’—personal tutors, e-tutors, e-exercises, e-counselors, counselors, coaching, e-coaching, CDs, disparate guide/reference books, educational content on TV and mobile phones, specialised ‘learning methodologies’ such as Indian Vedic math, Japanese Kumon math etc.

The ‘school—home connect’ has also perceptibly worsened with multi-point contacts for educational needs of the students. School and home have become discreet learning resources and platforms for the students leading to erosion of accountability of schools as the prime driver of learning capability and practice. The fragmented, ‘over-assisted’, and weak school-home connect of the educational ecosystem severely afflicts the key purpose of the educational system—enabling ‘learning to learn’ skills among students. As a result the quality of education is a subject matter of grave concern across the globe and it particularly causes immense stress across the stakeholders—students, parents, teachers, principals, administrators.

Within this fragmented ecosystem, the education system itself has become limited and weakened by some of their current resources, processes, practices. To be true, the growth of the supplementary education, weak student-teacher connect and ‘rote learning’ instead of ‘self-learn capacity’ are just the manifestations of the limitations. The following are the five key limitations of the education system per se:

1. Highly stretched schedule of teachers for ‘routine tasks’ such as classroom instruction, copy checking, administrative tasks (leading to limited time for personalised attention to each child). To top it, there is limited breakthrough innovation in classroom instructional resources beyond books, chalks, blackboard, some models
2. Poor quality, quantity, ease of access of knowledge base on the state of curricular and non-curricular development/progress of each student, section and class as a whole
3. Only rudimentary ‘top-down connection’ between home and school or institute as one continuum for a student's development/progress
4. Almost complete lack of ownership among schools towards the learning resources and practices at home including effective parent guidance, handholding and ‘education’ and
5. Weak teachers' training and development infrastructure and commitment leading to ‘gapped out’ teacher pool as well as out-moded organizational structure, processes and values still running the schools and their administrative bodies.

Extensive infusion of technology, especially I.T., into education's processes and resources was widely seen as the enabler for personalised learning context for each learner, supporting instructional quality and effective school-home continuum. School's own portal, third-party educational portals, e-mails, chat, teachers blogs, ‘first generation’ digital content and visuals, mobile messaging with parents, online assignments etc. were some initiatives in this direction.

However, despite a decade into using I.T. to secure ‘quality education for all’, no scalable model/solution has emerged. In fact, a review of the existing patent, published application and articles is briefly described in the following paragraphs to specifically bring out the state of art in ‘e-led learning’.

US Publication no 20070196807 describes an I.T.-based system which is a virtual school (yet another supplementary education) with its own set of trained teachers at hand for online and offline support for students in ‘regular schools’. For home schoolers it offers complete schooling solution with the help of a ‘caring adult’ who would need to spend fairly substantive hours every day teaching the home schooling children.

US Publication no 20030152904 discloses an online content delivery mechanism suitable as supplement or complement to classroom transactions.

U.S. Pat. No. 7,280,991 relates to a system which is for simulation of expected business scenarios and training people for better response in those business situations which is a rule-based expert training system for a goal-based training prodding the user towards that goal.

U.S. Pat. No. 6,988,138 discloses a networked learning environment which is essentially about a portal system which facilitates a network of exchanges and content among students, teachers, administrators, content providers, inter-institutional collaborations on content.

An article entitled “Portals: Primary and Secondary Education” talks about the Microsoft portal solutions which enables schools and school districts to quickly build and deploy Web-based learning environments. Portals provide easy access to curriculum resources, student records, and classroom materials and activities, and they enable students and teachers to collaborate through project-based websites. It's primarily a Learning Management System (LMS) for schools deployed on school's servers for digital content management and ancillary processes accessible on net and within school premises.

There are other portal kind of products for bringing together all the stakeholders together for information sharing and collaborations with Learning Management System (LMS) and administrative facilitation at heart unlike the benefits offered by the present invention.

SchoolZone—Web Portal Technology and Service, a new information system being developed by Edmonton Public Schools, which provides parents and students with secure access to school and student information and is designed to enhance the relationship between school and home. SchoolZone provides online access to daily homework assignments and class news from all of the students participating in the classroom and the teachers gathered together in a convenient calendar format.

An article titled “Kaleidos Learning Platform: Portal+” is talking about Portal+—a module of the RM Kaleidos Learning Platform—a family of products and services that enable local authorities, schools and clusters of schools, to meet a wide range of goals. From extending school access, personalising learning and providing new and exciting ways of communicating and collaborating, to creating and delivering exciting lessons, meeting government targets and reducing paperwork.

An article titled “Response to “Collegemantra.com—Education Portal or Social Networking Play!!!”” talks about an online education portal which connects all the education entities with each other so they can share their knowledge with each other.

The paper entitled “Computer-assisted learning for mathematical problem solving” proposes a computer-assisted system named MathCAL, whose design is based on four problem-solving stages: (1) understanding the problem, (2) making a plan, (3) executing the plan and (4) reviewing the solution. Unlike the present invention it's focused only on math, focused essentially around the learner, not self-managed or self-tutored for entire curricular transactions and does not offer integrated learning content package too.

The product entitled “Intelligent tutor—math learning software” describes a Math Tutor Educational Software that features self-paced lessons that enable students to master the concepts of math and build proficiency in problem solving. Unlike the present invention, it is limited to math and grades 6-12, does not envisage 360° learning context, and it is essentially a self-study supplement with limited or no linkages with the formal in-school resources, content and methodology.

The press release entitled “Emteachline Mathematics Software—Your Personal Math Teacher” describes PC-based interactive mathematics software that tutors in solving math problems. This encyclopedic software contains hundreds thousands of fully explained step by step solutions to math problems from basic to advanced and thousands of related definitions, rules, formulas and theorems based on a unique teaching technology. Unlike the present invention, it's limited to math, essentially a self-study supplement with limited or no linkages with the formal in-school resources, content and methodology, offers limited interactivity as it uses multiple choice answers as an input option for students.

The product entitled “MATHGURU” offered by Educomp Solutions Ltd describes an innovative math-help program designed to provide solutions to the student's problems in a step by step fashion. Mathguru has a repository that contains all math problems and their solutions, from the NCERT Math textbooks, for Classes VI to XII. There are over 10,000 solutions available on the Mathguru website. Unlike the present invention, this offering is non-interactive, limited to math, operates only on a set question bank, not self-tutoring i.e. no question inputs from learners and does not afford a 360° view of students progress or collaboration among various stakeholders.

US publication no 20050058976 relates to software that monitors user choices and provides feedback to the user in real time. The system monitors student choices as the student walks through the steps of solving a problem and provides feedback to the user indicating whether or not the user's input is correct. Unlike the present invention, this offering is limited to math, more specifically to Algebra, does not offer animated self-learning contents/visuals and does not offer 360° system.

US publication no 20060024649 relates to educational software, and a handheld device that monitors user solutions to math problems and provides feedback to the user in real time. The method provides a handheld device for aiding students in solving mathematical problems. Unlike the present invention, this offering is limited to math, more specifically to Algebra, it's particularly tied to a handheld device, it's not self-tutoring in its scope and does not offer 360° system.

U.S. Pat. No. 6,540,520 discloses an improved intelligent tutorial system utilizing rules that evaluate a constraint on a solution and compare this constraint with an improved, more general rule set. A step in the solution to a problem as input by the student is evaluated by the system. In a wrong step, an intelligent tutorial tries to match the mistake made by the student by processing the answer by all buggy rules, pre-programmed by the expert, to determine a possible reason why the student missed the solution. The standard program, then, can judge that the answer is wrong by taking the equivalent steps as the student to come up with the same wrong solution. Unlike the present invention, it's not integrated with an extensive learning content platform and does not offer 360° system.

US publication no 20040018479 relates to computer-implemented instruction. The method conducts an interactive dialogue with a student helping them with correct solutions to a problem, by presenting problems in multiple parts, providing hints or simpler subparts and responding usefully to the student's wrong answers. Unlike the present invention, this offering is wholly non-intelligent to the extent that it's driven out of teacher/administrator provided questions and clues, it's not content a learning content platform, the system is rather a shell with limited assessment content of its own and it does not offer a really complete 360° system.

U.S. Pat. No. 6,865,370 relates to a system which generates study materials that introduce the subject to the user. After studying the presented materials, he can begin asking questions. The system generates an answer to each question, and presents it to him. The system also compares the question with one or more questions previously entered by him. The comparison determines his understanding level in the subject. If the comparison indicates that he is weak in a certain area, the system can present detailed study materials covering those areas. The system also stores the question he just asked, so as to compare to questions he might ask in the future. Unlike the present invention, this offering is not a diagnostic platform with step-by-step solution entered by the user student, it's non-intelligent to the extent that it's not driven out of mathematical or other scientific rules and does not offer 360° system.

U.S. Pat. No. 7,338,287 relates to a method of providing a solution to a given problem. The solution to the problem can be an interim solution comprising a mathematical equation imbedded therein, and can further include the steps of providing a math computation program capable of running solutions to mathematical equations, and running the solution to the mathematical equation. Unlike the present invention, this offering is not a diagnostic solutions platform, does not offer learning content adequate for self-tutor a syllabus and does not offer 360° system.

US Publication no 20010051330 relates to the methods for providing remote teaching which utilize a two-way communication to communicate over a network such as the Internet between a provider of remote teaching and its student. The system implements the method for providing remote teaching to a student at a terminal connected to the apparatus through a network, comprises a question database including questions to be given to students, an answer database including an answer key for the questions in the question database. Unlike the present invention, this offering is not a diagnostic solutions platform, offers simple user input limited to entering answer of a selected saved questions, it's a shell program with limited content of its own and does not offer 360° system.

Publication No JP2002268533 relates to a self-learning system which delivers teaching materials to the learners and responds to the questions from the learners by the replies based on the past question case examples and the replies formed by a lecturer and a portable unit which is carried by the lecturer, receives the questions from the learners and makes and sends the replies for the same to the learners. Unlike the present invention, this offering is not a diagnostic solutions platform, offers simple question input option, it is a wholly non-intelligent system to the extent that it is driven out of a database of replies and not mathematical or scientific rules, it is a shell program with limited content of its own and does not offer 360° system.

However, the quality of current and future pool of teachers can only be affected incrementally. To be realistic, it will take a couple of decades to see any large scale changes on the ground on this dimension. The school-home continuum is no less daunting a challenge given the complex time, academic and the role-modeling demands on parents for the home to emerge as an effective complement to schools in education. Similarly, the level of integration of the resources and stakeholders is very limited despite the fact that Information Technology can enable a very powerful integration. If the current state of education is stressed and stretched and leaves a lot to be desired, then it's going to be far worse in the coming years because the demand for quality education is spreading like a wild fire, globally. Not surprisingly, a spate of national legislations and educational reforms, across the globe, is catalysing quality education to all, always, everywhere.

Fortunately, Information Technology can be innovatively harnessed to address these issues—quality teachers in requisite numbers in every village or community, enabled parent community in every home, and a comprehensively integrated educational resource base—across the world. The world cannot afford to wait for a few decades to reach conventional quality education resources (e.g. teachers for various subjects and level, books, laboratory) to each village or community across the globe.

It is this context that demands an education system which is independent of any of the conventional learning resources e.g. teachers, laboratories, peers in school, educated parents to adequately re-inforce/support the learning at school ensuring the reach of quality education. Therefore there is a need for an independent learning system that can enable any individual learner to self-tutor and self-coach himself or herself at his or her convenient pace, time and place and it is the only educational space besides the school (the schools processes and resources are also significantly and appropriately re-designed).

Fortunately, the emerging advances in Internet, access devices and software is heralding increasing personalization of communication and information and 360° knowledge context for everyone globally. In turn, it's opening up unprecedented opportunities for reaching just-in-time and just-the-need services to individuals.

However, such opportunities remain grossly unaddressed in education.

Thus, to overcome the limitations in the state of the art, the present invention discloses a device and system for enhancing learning and providing an edge to the education system. The device and system provides not only self-checking assignments, comprehensive and extensive visually rich digital chapters, diagnostics, intelligent and teacher mediated feedback, peers online for collaborative assignments, personal and social development resources, non-intrusive parental guidance but also authentication mechanism to create the most child-safe portal possible—a necessary condition for the Internet-based learning resources and processes to bear significant impact on the ground. The present invention also provides by offering a combination of intelligent and non-intelligent platform which provides a 360° utility which integrates all the stakeholders. The platform provides diagnostic solutions that is linked with the content of the platform as well the content inputted by the user. Moreover the content is not limited to one particular subject rather it is multidisciplinary and the content is generated and taken from all the possible resources on top of the extensive content on the platform itself, as part of the system. The platform is accessible over a wide range of devices and has numerous interface enabling appropriate usage.

### OBJECTS OF THE INVENTION

The principal object of the present invention institutis to provide a self-managed digital learning system with a specialized access device that is child-safe’ (safe for view/read/audio for children), enhances the learning experience and suitable for personal possession for personalized and secure access to educational resources and community. This system has embedded intelligence based on longitudinal and latitudinal analysis of the choices made by the users on the system.

An object of the present invention is to provide a device and system which enables educational institutions to become the sole provider of institutional education without any need for any supplementary education outside the institution and the family.

Another object of the present invention is to provide a user interface which has a step-self-checker as part of the self-tutoring platform.

Yet another object of the present invention is to provide a user interface with ‘curriculum-specific visual learning chapters’ as part of the self-tutoring platform.

Still another object of the present invention is to provide a uniquely personalized learning system with the entire ‘real people’ context of each user student brought on the system, live or ‘later’, for the most effective emotional and substantive handholding to each user student.

Another object of the present invention is to create a truly 24×7 learning center because of the self-checking capability of the system with no mandatory need for live tutor support.

Yet another object of the present invention is to offer the unique ability of ‘online live homework test bed’ wherein parents or another authorized user can concurrently view the choices being made by a user student and advice/support the later in making the right choices in problem solving.

Still another object of the present invention is to make all decision-making, including progress/development of each student, in educational institutions comprehensively data-driven.

Another object of the present invention is to transform the classroom content quality to a level that the ill-impacts of the inadequacies of the teachers on the students' interest in learning as well as the level of understanding are significantly avoided.

Yet another object of the present system is to transform the pre-class, in-class, post-class routine of the teachers to enable them to spend almost 100% of their time in the institution ‘face-to-face’ with students—individually or groups.

Still another object of the present invention is to very greatly strengthen the ‘school—home’ connect by creating a seamless content and process superhighway between school and home as ‘unit users’ as well as among the individual users.

Another object of the present invention is to dramatically lower the manpower intensity of tutoring by enabling uniquely comprehensive ‘clicks, keys, touch, voice’ analysis of each user for each explicit and implicit assessment or assignment or choices made in other designated contexts in the system.

Yet another object of the present invention is to create the safest children-portal possible using only authenticated identities of student users to interact with each other (to remove one big hurdle in harnessing the Internet for education)

Still another object is to showcase the world's first inclusive portal at the global level based on ‘real communities’ (such as a school's students, teachers, parents, alumni) and offer educational and all other goods and services to all the users with the unique advantages of real community.

Another object is to facilitate creation of uniquely effective peer-learning networks that are powered by tools to concurrently view each others choices or steps in an assignment or numerical problem or even in an assignment or numerical problem or even in an animated learning object in live or ‘later mode’ (analytical reports after an online session ends).

Yet another object is to extend the real community on the 360° learning system to geography-based local portals and non-geography-based portals.

Still another object is to enable and facilitate the reach of world-class digital content and processes through distributed language translation of the content and processes.

Another object is to catalyse faster development of Application Service Provision (ASP)-based seamless content and collaboration platform which can rapidly become one default standard for various access devices of the users.

Yet another object is to redefine economic modeling of ‘intelligent educational content and processes’ so as to reach transformational education system to first-generation learners across the globe in affordable and sustainable ways.

Still another object of the present system is to make ‘quality and anywhere tutoring available to all’ feasible.

Another object of the present invention is to provide an independent learning system that which is closest to the actual context of a user student by bringing alive highly personalized learning context for every user student.

Yet another object of the present invention is to work as self-tutoring, self-coaching platform that effectively negates the need for any supplementary educational support beyond the school and home.

Still another object of the present invention is to provide an education system that is the common, singular educational platform accessed by the students, teachers, parents and school administrators for the entire gamut of educational tasks and resources.

Another object of the present invention is to provide an education system that is almost one-stop educational platform offering extensive content and diagnostic tools for a wide spectrum of subjects at least up to K-12 education.

Yet another object of the present invention is to provide an education system that is integrated across subjects and topics as relevant to offer the most realistic analytical support to the teachers, students, parents, administrators on the actual state of progress/development of every child.

Still another object of the present invention is to provide an education system that is composed of an integrated self-diagnosing assignments/exercises and self-learning visual and textual content.

Another object of the present invention is to provide an independent learning, system which has an open-ended component (‘intelligent’) as well as a pre-defined component (‘non-intelligent’ and created through a ‘meta code’ for answers steps) to best suit the nature of the assignments/assessments/exercises in various subjects and topics therein.

Yet another object of the present invention is to provide an independent learning system which is available in multiple languages, multiple curriculum.

Still another object of the present invention is to provide an independent learning system which offers the widest range of response facility to the students.

Another object of the present invention is to provide an education system that is also a very extensive, quick and controlled platform for teacher training—both curricular and behavioural as well as ongoing refresher.

Yet another object of the present invention is to provide an education system that offers the most effective platform for continuous assessments for student's progress in non-testing conditions at least at home by using diagnostic visual learning objects.

Still another object of the present invention is to provide an education system that offers school administrators, governments, higher educational institutions, businesses the most extensive (longitudinally and latitudinally) record of a students development and growth in the most natural setting (the ‘non-testing’ daily routine).

Another object of the present invention is to provide an independent learning system which creates a 360° educational context for each student.

Another object of the system is to provide an independent learning system which will allow users to feed their own questions/queries and the system will enable them to input step-by-step solution/response and auto-check them with a goal to reach the users to the correct/proper answer for an increasingly wide range of subjects and topics.

Another object of the present invention is to provide an independent learning system that enables homes to be increasingly independent unit of academic education by enabling students and parents to self-educate and thereby enabling parents to effectively support their children in academics.

Another object of the present invention is to provide an independent learning system that enables parents to be effective tutors/academic coach for their children in the widest range of subjects (even beyond their own academic accomplishments) by intensive and extensive analysis of their children's progess, intelligence-based diagnostic reports on likely academic deficiencies in their children, peer-level interactions with other parents/teachers/tutors and self-learning academic modules as well as access to the right/appropriate answer/response to the choices made by their children.

Another object of the present invention is to provide an independent learning system which offers an intelligent content organization for the various categories of users based on their past choices/responses in the system; for the student users, for instance, the system offers once-click revision content/questions on a chosen topic (out of a similar advisory at the subject and topic level) based on the past record of performance on the topic.

Still another object of the present invention is to provide an independent learning system which allows the users to broadly define and redefine the content organization rules to a great degree; for instance, the student users can change the level of incorrect/inappropriate responses to various assessments or choices for creating the revision listing of subjects/topics/questions/content.

Still another object of the present invention is to provide an independent learning system which is accessible over a wide range of devices using the Internet Protocol while a specialized device is proposed as art of the system.

Another object of the present invention is to provide an independent learning system which offers multiple level of learning context—micro-questions/mini-assignments/quick-assessments/small-exercises/responsesin-animated-visuals to full questions/assignments/assessments/exercises.

Yet another object of the present invention is to provide an independent learning system which despite being intelligent does not offer the correct solution steps (answer step hints) without making the user input correct or incorrect answer at least once for each step in a solution and in that process compelling critical interactivity with the user and creating some take-away/lessons for the user in attempting to solve every assignment/assessment/problems/exercises.

Still another object of the present invention is to provide an independent learning system which is designed to induce maximum interactivity with the users by restricting the option of copy and paste of steps from the answer step hints in the system or from an outside source.

Another object of the present invention is to provide an independent learning system which dramatically reduces the unproductive ‘overhead’ time and effort of teachers in understanding the most detailed state of progress of a student, a group of students, a section of a class, all the sections of a class on a critical step of an assignment/assessment/exercise/problem, or all the steps of an assignment/assessment/exercise/problem or a sub-topic or a topic of a subject.

Yet another object of the present invention is to provide an exclusively ‘real-identity-based’ authenticated relative merit or Competitive Quotient assessment system, uniquely tailored for every competitive examination, and offered as sub-topic/topic/chapter-wise diagnostic Competitive Quotient or full-syllabus effective Competitive Quotient; these competitive quotient assessments can be time-bound or ongoing to create unique relative merit position in a dynamically competitive situation.

Still another object of the present invention is to provide an user interface for self-tutoring, self-coaching that offers step-wise integration of electronic pen and pad or equivalent devices with the step-wise diagnostic system for assignments/assessments/exercises/problems.

Yet another object of the present invention is to provide an independent learning system which allows extensive social interaction tools such as blogs, chat, messaging, discussions.

Yet another object of the present invention is to provide an independent learning system which allows extensive ‘general knowledge, personality, development’ tools such as language learning, mathematical aptitude, comprehension, news, research in various fields.

Another object of the present invention is to provide a dedicated digital learning tool in the hands of the students which offers child-safe internet-access and the increasingly powerful and extensive and personalized digital educational resources and community.

Yet another object of the present invention is to provide an user interface that offers a restricted usage of the step-wise diagnostic system for assignments/assessments/exercises/problems in the classrooms too with the students using laptops/personal computers or a dedicated electronic response devices available with the students.

Still another object of the present invention is to provide an independent learning system which enables the various levels of academics in educational institutions to specifically handhold and guide the teachers in how best to address the varying academic needs of the various sections of a class.

Still another object of the present invention is to provide an independent learning system that allows live access to the working screen of the users students to their teachers, parents, identified peers or others on the screen of any IP-enabled device.

Another object of the present invention is to build a simple user interface for all authorized users to add their own content and diagnostic assessments using the system, including collaborative co-creation of all kinds of educational content in an authorized access environment to support an identified learner or a group of learners.

### SUMMARY OF THE INVENTION

Accordingly the present invention relates to, a 360° learning system wherein the system is creating the next-generation education system, a self-managed learning ecosystem, a personalized learning context for each learner, by enabling a uniquely integrated and comprehensive digital content and process platform that has 360° span of association with respect to individual users, institutional users, domain, enablements, access, benefits and hardware (including a dedicated ‘PDA’ optimized for learning purposes to be an optional access device for students)

In a preferred embodiment the present invention provides a self—managed intelligent learning system operable only on a user after a threshold amount of clicks and choices on the system with the help of a device, said system further comprising self-tutoring-diagnostics with minimum text and maximum animated visualization; indirect or hidden diagnostic assessments; and an assignment checker.

In another embodiment of the present invention, the device has a special user interface for enabling the user to provide inputs in form selected from the group comprising a single keystroke, touchscreen or audio instruction for a hands-free operation.

In yet another embodiment of the present invention, the device is provided with various content types including text, audio/video streaming, animation.

In still another embodiment of the present invention, the device works on various radio technologies such as but not limited to GSM, CDMA, W-CDMA, WiMax.

In another embodiment of the present invention, the device works on various wire line technologies such as but not limited to RS232, DOCSIS.

In yet another embodiment of the present invention, the device and system which records each step of the users in the use of the digital resources.

In still another embodiment of the present invention, the system shows a recorded step, in the form selected from the group comprising live or later in raw or intelligently diagnosed form.

In another embodiment of the present invention, the device carries out analysis and assessment on the basis of choices made by the user, which are recorded and diagnosed and pattern of learnt and weak areas in the non testing conditions are found.

In yet another embodiment of the present invention, the device has an authentication mechanism to verify immediate context of the student/user.

In still another embodiment of the present invention, the device has an authentication mechanism which works on real identities which are established on the basis of relationships within an institutional setting.

In another embodiment of the present invention, the system can be used for non-geographical dependent e-learning, corporate management, geography independent government management, e-tutoring with the system analyzing and sending the assessment to the person.

In yet another embodiment of the present invention, the system may be incorporated anywhere, in any portal.

In still another embodiment of the present invention, the system can be customized as and when required.

In one embodiment the device of the system provides an interface for enabling the users to feed their assignment or assessment questions into the system, not already in the bank of the system, and then solve the questions in fixed steps.

In another embodiment of the present invention, the system can take input selected from the group comprising touch, voice, key, mouse, for logging in.

In yet another embodiment of the present invention, the system can work with any computing device such as device connected to the internet, personal digital assistant, mobile phones, laptops.

In still another embodiment of the present invention, the system can be used as an e-commerce portal bringing together educational and non-educational goods and services.

In another embodiment of the present invention, a system, wherein the system offers the unique ability of ‘online live homework testbed’ which enables the users to feed their assignment or assessment questions into the system, not already in the bank of the system, and then solve the questions in fixed steps (without getting to see the right answer steps straight away) without any assistance or wait for a few hours (for the 360° learning system providers to feed the answer steps digitally into the ‘system backend’) and then solve the questions online without any live or direct human intervention for homework completion.

In yet another embodiment of the present invention, a 360° learning system, wherein the system creates the safest children-portal possible using only authenticated identities of student users to interact with each other (to remove one big hurdle in harnessing the Internet for education).

In still another embodiment of the present invention, a 360° learning system, wherein the system provides means for widest sharing and exchange among users in the comfort and assurance of real identities.

In another embodiment of the present invention, a 360° learning system, wherein the system progressively builds the most inclusive ‘real community’ based portal for offering educational and all other goods and services to all the users with the unique advantages of a real community.

### BRIEF DESCRIPTION OF THE DRAWINGS

FIG. 1 shows the schematic diagram of 360° Learning System.

It is to be noted, however, that the appended drawings illustrate only typical embodiments of this invention and are therefore not to be considered for limiting of its scope, for the invention may admit to other equally effective embodiments.

### DESCRIPTION OF THE PREFERRED EMBODIMENTS

The following description incorporates the disclosures of two cognate provisional patent application Nos. 1315/DEL/2008 of May 30, 2008 and 1997/DEL/2008 of Aug. 22, 2008.

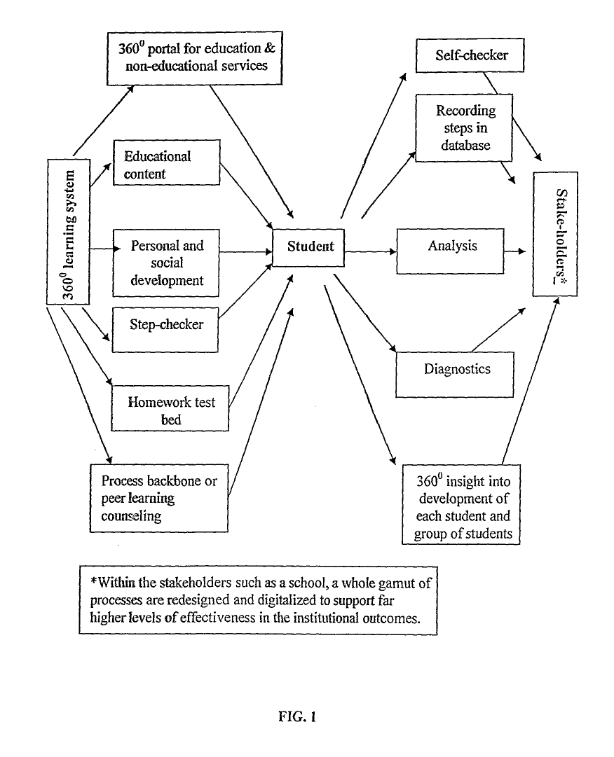

As compared to e-tutoring systems where manpower is the key element in order to deliver the service, the present system is an ‘intelligent system’ and does away with the necessity of live and ‘trained/teacher’ manpower to address the tutoring benefits and live tutor becomes an optional, occasional need. The present invention provides personalized learning with the help of an intelligent learning system. Unlike the more common ‘rule-based’ intelligence embedded learning system that essentially engages in ‘faceless’ interactions with the users, the 360° learning system is operative only on a user after a threshold amount of clicks and choices on the 360° learning system by that user. The present invention involves self-tutoring-diagnostics with minimal text and maximum animated visualisation and indirect (hidden assessments) diagnostic assessments and assignment checker. The present invention also provides for a complete integration of all stakeholders around the user to offer continuing re-inforcement to the user for development and also enable a longitudinal development plan of users' each interaction with the 360° learning platform. This is shown in FIG. 1.

The present invention also provides the instructional material which may or may not be available or accessible live during the interaction with the 360° learning platform. The instructional inputs may come post platform use from any or all of the other stakeholders e.g. parent, teacher, tutor, principal, peer students etc.

Analysis is available to teachers, seniors, parents which also includes longitudinal and cross-subject analysis to best read the development of the student.

Digitalising all processes and resources—all text, visualisations, derivations, exercises used by an institution are converted into software so that they can be accessed in various formats over any digital display screens. The digitalisation also proceeds on its own by the 360° learning system provider based on feedback and usage reports of the individual users too.

Recording of each step or activity (clicks on the digital display screen and the keys on the keyboard or the voice-stimulated instructions) of the users especially the students in the use of the digital resources and showing it live or later in raw or intelligently diagnosed form to all the stakeholders concerned to dynamically recreate the learning processes and resources around each student to best complement the learning attainment, need and style of each student.

The ‘choices’ made by the students while playing with the visuals are recorded and diagnosed and ‘pattern’ of learnt and weak areas in the most ‘non-testing’ conditions.

The present invention provides a 360° learning system wherein the system is creating the next-generation education system, a self-managed learning ecosystem, by enabling a uniquely integrated and comprehensive digital content and process platform that has 360° coverage with respect to individual users, unit users, domain, enablements, access, benefits and hardware.

The present invention provides a 360° learning system wherein the system captures all the choice made by the users on the system in the form of ‘clicks, keys, voice, touch’ (but not limited to these) to offer:
1. online (live) guidance, leading to solution wherever possible, in response to such ‘clicks, keys, voice, touch’
2. online (live) or offline (later) assisted or non-assisted supervision of parents, teachers, tutors, peer students or any other authorized people on the pattern of the ‘clicks, keys, voice, touch’ and
3. widest possible framework of content (academic, personal growth, social development as of now) for the most appropriate understanding of the learning context of each student
4. unique ‘real portal’ out of aggregation of ‘real community’ of users.

The present invention provides a 360° learning system wherein the system has the coverage aspect for the following:
1. individual users (students, parents, teachers, principal, peer students, tutors, authorized others)
2. ‘unit users’ (school, home, various scholastic and non-scholastic departments in schools, tuition providers, coaching providers, freelance counselors and such others)
3. domain (academic learning, personal growth, informed career tracks, social development, e-governance, corporate development among others)
4. enablements (visualization, diagnostics, self-checking assignments, readings, ‘homework testbed’, language labs, competitive quotient assessments, social networking, blogging and such others)
5. access (24×7, anywhere, ‘live’ or ‘later’, user identity management for relevant window of information, levels of rights and secure access)
6. benefits (all educational goods, services and community; many other ‘non-educational goods and services becoming effectively feasible to an ‘organic real community’ as in this system)
7. hardware (the system runs as an Application Service Provider application accessible from any browser-enabled internet-connected display device and interacts on any stimulation—click, key, voice, touch)

The user interface of the step-self-checker part of the self-tutoring platform; the step-self-checker has the following components:
1. four options—
   a. ‘online homework testbed’ which takes inputs from the students the homework questions given by their respective schools to help them solve homework questions without any physical tutoring help and
   b. ‘online book step-checker’ which has step-wise solutions to all exercise questions of listed books to help students endlessly practice exercises without any physical tutoring help
   c. ‘explicit visual step-checker’ which seeks the answers steps through interaction with visual content
   d. ‘implicit visual assessments’ which do not appear to be assessment as such but record the choices made the users on the visual content and implicitly assess the understanding of the user students
2. appropriate interface for each type of question taking advantage of the opportunities in software interface design keeping some semblance of similarity with ‘pen and paper’ solution
3. default recording of each step of the solution offered by the students in all the four options mentioned above and saving it in the database of the system against the concerned students as well a tag on the questions too for analytical references for all times
4. display the performance of each student—question wise, step wise, wrong step/right step wise and more dimensions—to the teachers, parents, principal, tutors and authorised others in the formats relevant to their respective need and limit.
5. mix and match this data with all other academic, personal and social progress data of the student to provide most insightful state of development of each student
6. interface for students to critically analyse their performance with respect to others and over time (and such other view windows) and quickly retrieve the questions which had more mistakes or repeated mistakes (and such other view windows).

The user interface of the ‘curriculum-specific visual learning chapters’ part of the self-tutoring platform; the ‘curriculum-specific visual learning chapters’ has the following components:
1. two options:
   a. instructional chapters used by the teachers in the classrooms
   b. learning chapters used by the students, parents through the school's portal with explicit and implicit assessments (which get recorded in the system database against the user and the chapter)
2. each chapter has animated visual presentation of all the concepts, illustrations, activities, experiments, exercises and all the definitions and derivations of that chapter (including references to other relevant definitions, derivations, formula etc.) to be a complete visual learning module

The ‘live’ data thus generated creates the bedrock of the in-class transactions—the teacher comes to know exactly her/his deliverables.

The administrators also get a unique window into the learning attainments of students and directly and focussedly handhold teachers with specific feedbacks on how they can improve the learning attainment of each student.

The authentication of the user identity is an integral part of the process automation and the comprehensive rights of self-management of the 360° learning system to the institutions ensures that the registration and deactivation of the users takes place only through a designated administrator of the institution. The 360° learning system provider or anyone else cannot register or deactivate users of an institution without leaving a trace and therefore easily identifiable as null and void. The authentication process uses multiple points of authentication.

Once users log in to the log-in interface of the 360° learning system and the welcome page assigned for the services entitled to them (as student, parent, teacher, school administrator, free-lance educationists, counselors) opens.

The welcome page offers links to various services offered to users. The users launch the services by a click on them and read or actively engage in an interactive way with the content. Users engage in active collaboration for academic, personal or social reasons. The system offers extensive analysis of clicks and choices of students which are almost as real as face-to-face pen and paper exercise and the analysis could be accessed anytime, anywhere by a tutor at his/her convenience and be reported to the student anytime, anywhere.

The 360° learning system offers 360° learning opportunity with personal growth and social development side-by-side to academic transactions. The former two are necessary and sufficient complement to the latter to work constructively with each student.

The ‘longitudinal dimensions’ of the 360° learning system is another key feature and enables users to make their own window of evaluation that throws up new perspective on the state and needs of the users. All services offer fairly detailed archiving of the choices made on the 360° learning system.

Over a timeframe of a few years of usage, intelligence embedded advice and support is offered to the users based on a critical mass of previous ‘click choices’ on the 360° Learning System. The intelligence grows with usage on the system as well as the intelligence embedded in the software and hardware of the system.

The system is a uniquely personalized learning system with the entire ‘real people’ context of each user student brought on the system, live or ‘later’, for the most effective emotional and substantive handholding to each user student. The present invention provides to create a truly 24×7 learning center because of the self-checking capability of the system with no mandatory need for live tutor support.

The present invention also offers the unique ability of ‘online live homework testbed’ which enables users to feed their assignment or assessment questions into the system, not already in the bank of the system, and then solve the questions in fixed steps (without getting to see the right answer steps straight away) without any assistance or wait for a few hours (for the 360° learning system providers to feed the answer steps digitally into the ‘system backend’) and then solve the questions online without any live or direct human intervention for homework completion.

The present invention has the components of the next generation of learning resources and processes which include—
1. each students ‘real community’ brought online to ensure capacity building of the entire educational ecosystem of each student
2. curriculum-specific visual learning chapters (animated concepts visuals, theorems and derivations and examples/exercises comprehensively covering chapters as one continuous module),
3. self-checking assessment platform for assignment and/or prescribed books' exercises,
4. ‘live’ or ‘later’ analysis of the students' ‘clicks, keys, touch, voice’ on the system, by the schools' teachers or parents or tutors or peers or authorized other, to offer the necessary emotional and academic support to students
5. ‘online homework testbed’ for autonomous homework completion by the students
6. integral education approach wherein the broader dimensions of academic, personal and social development together constitute the knowledge base on each child to analyse his/her progress and devise the interventions
7. better ‘stickiness’ to the system for non-student users by inventing new generation advantages of the ‘real community’ aggregated by the 360° learning system to secure more benefits in education (e.g. group buying of books by parents of a school, in-school career counseling in a school by parents from another school in the town) and other aspects of life (e.g. health, e-auction, e-commerce, e-debate, e-ticketing) and
8. multi-dimensional institutional transformation of schools for better economics for all stakeholders and far better impact on each student

The present invention intends to dramatically lower the manpower intensity of tutoring by enabling uniquely comprehensive ‘clicks, keys, touch, voice’ analysis of each user for each explicit and implicit assessment or assignment which can be analysed by any ‘remote tutor’ at their convenience and recommendations for improvement or new concepts can be posted for the students for reference any time later (thus, two things will happen—first, tutors can change without any significant loss of ‘memory’ on the child's details and second, tutors can be ‘active’ during the school hours too and multiply their span of tutored students without hurting the basic tutoring need of transactional help while solving an assignment or assessment).

The present invention enables an online platform that enables the school teachers to tutor their ‘own’ students (students actually taught a subject in the school by the respective teachers) after the school hours but without much demand on the teachers' time at home by providing the teachers with a live screen-view of the steps written by the various students (the screen will be simple and direct and show, for instance, only the students who may be making mistakes while solving an assignment or assessment) while handling an assignment or assessment on the step-self-checker and help the student immediately, if necessary, and revisit concepts in the class the next day or later if a group of students are found conceptually deficient on a topic; ‘teachers as tutors’ also hold the promise of increasing the income of teachers in schools without increasing the cost of education to parents as the money spent by parents on supplementary education will get partially diverted to teachers (with some saving for the parents too).

The present invention is the safest children-portal possible using only authenticated identities of student users to interact with each other (to remove one big hurdle in harnessing the Internet for education).

The present invention helps in the widest sharing and exchange among users in the comfort and assurance of real identities.

The present invention is based on ‘real communities’ and it is characterized by the following:
1. an organic system of continuous authentication of identity of each user for access to the portal—secured by linking the access to the portal to membership of the users to identified ‘real community’ (such as an educational institution, a business organisation) which effectively transacts at least some of its critical ‘business’ processes on an Internet-based software platform and ‘routinely’ keeps all current relevant details of all its members
2. of the innumerable ‘real communities’, the chosen ones to be a part of the portal are such that obtaining membership of such communities follows a fairly organized process and criteria
3. of the innumerable ‘real communities’, the chosen ones to be a part of the portal are such that the termination of membership or willing exit of a member of the community follows a proper and tight exit process
4. of the innumerable ‘real communities’, the chosen ones to be a part of the portal are such that the communities are able to exert a reasonable code of conduct on the behaviour of their members
5. access to the portal for people without the possibility of ‘an organic system of continuous authentication’ is clearly notified and restricted in some ways
6. the portal and communities that are part of the portal have some agreement to acknowledge each community's explicit or implicit commitment to facilitate enforcement of a certain code of conduct of the portal on their members when they are interacting directly on the portal
7. the portal enables the communities to best coordinate their routine activities and in that process create new benefits of geographic proximity among members while interacting with the global community on the Internet.

The present invention progressively builds the most inclusive ‘real community’ based portal for offering educational and all other goods and services to all the users with the unique advantages of a real community.

The present invention facilitates creation of peer-learning networks wherein the concerned network members can use the 360° learning system to extend the content coverage and fine-tune the digital content and processes to help each other within the network and also use it for economic benefits (such as core network members helping associate members of the network in their academic transactions, personal growth and social development).

The present invention extends the real community on the 360° learning system to geography-based local portals (such as district portals for all the users belonging to a particular district) and non-geography-based portals (such as matrimonial services) to address the crucial need of authentic exchanges and collaborations on the Internet (education along with health offer the best opportunities of real identity authentication).

The present invention enables and facilitates the reach of world-class digital content and processes through distributed language translation of the content and processes on the 360° learning system (build tools for easy translation of text in the content and process by any authorized user community).

The present invention catalyzes faster development of Application Service Provision (ASP)-based seamless content and collaboration platform which can rapidly become one default standard for various access devices of the users.

The present invention redefines economic modeling of ‘intelligent educational content and processes’ so as to reach transformational education system to first-generation learners across the globe in affordable and sustainable ways.

The present invention also provides an independent learning system which is a self-tutoring and self-coaching platform based on an integrated 360° education system—multi-disciplinary integration, appropriately included stakeholders, live or later support and collaboration, multi-dimensional collaborations among stakeholders, increasingly language-free, multi-media, real identities, multiple mentors, global, actionable steps for parents to support their children with necessary curricular and non-curricular aids to parents.

The present invention provides an independent learning system which is closest to the actual context of a user student by bringing alive highly personalized learning context for every user student by harnessing the micro-progress data on every user student to dynamically organize the most appropriate learning resources for them—customized and dynamically packaged content, informed parental and teachers support, analytically informed choice of peers for live or later collaboration, multi-disciplinary analysis and auto-generated revision content.

The present system comprises of diagnostic assessment and learning content (visual and textual) for a wide range of subjects at least in K-12 segment of education—curricular and non-curricular, covering topics comprehensively within each subject, by using multiple technology platform which enables to offer tailored interface for every topic along with integrated feedback and analysis (based on multi-disciplinary approach). Access to records of assessment of work done by students at home is available to the teachers in school and other stakeholders, global and multi-point collaboration among stakeholders which include peer-to-peer among students where they can collectively solve a problem or explore a multimedia lesson or create their question and answer bank with content to be accessible to all or limited set of users is also possible. The platform is a safe-for-children educational platform because it is based on real identities of users and being a multi-subject resource that is also customized to the curricular specifications of every user institution (over time every user student). The platform enables actionable steps to be taken by parents in the analytical reports on curricular and co-curricular activities of their children to ensure they are able to adequately support their children at home in the least time and effort. Appropriate and additional content for parents and other involved adults is provided to enhance their understanding of the relevant topics and subjects to most effectively support their children. Most importantly the present invention links the content with the diagnostic assessment which is an expensive and time consuming task and the diagnostic system is independent of whether the content is provided by the user or available on the platform.

The independent learning system is enabled with seamless integration capability with disparate institutional I.T. platform such as the I.T. system used in the schools attended by the user students or I.T. system used in the corporate where the parents of the user students may be employed. This is an organic functionality of this invention to the extent that it brings alive the entire educational resource pool of every user student on to one platform. In turn it affords the most comprehensive and consistent emotional, curricular and co-curricular guidance and motivation to every student.

The present invention provides for an innovative competitive quotient assessment system which generates overall relative merit, subject-wise, topic-wise, sub-topic-wise relative merit, local/regional/national/international relative merit wherever meaningful in some context to the users, juxtapositions the relative merit with absolute merit (the actual marks obtained based of correct response in non-relative context) for more precise recommendations to the users about further effort to improve the relative merit, unique relative merit for every competitive examination. The system best directs every user, by analyzing the competitive quotient of a user for a family of competitive examinations, to the most realistically achievable competitive opportunity. The system also offers live benchmark for competitive quotient to prospective students using the past batch of successful candidates in a competitive examination to undergo the current set of competitive quotient assessments, enables pre-defined and intelligent multi-disciplinary analysis of competitive quotient for every student in order to help users to best focus on their weakest knowledge areas in the overall frame of the curriculum of every competitive examination.

The present invention offers extensive student-wise, step-wise, question-wise, group-wise, section-wise, class-wise analysis of the responses/answers of user students to the teachers, parents, authorized others in graphical and tabular formats.

The present invention records each step of each assignment/assessment/problem/exercise done on the system by every student in every subject to offer extensive analytical reports on the users progress and state of educational accomplishments at any point of time.

The record of all the previous answer steps is displayed on the input screen too.

The invention innovates user interfaces which significantly minimizes the clicks and keys in inputting solutions to assignments/assessments/exercises/problems online by enabling complete or step voice responses/answers, a bundle of correct and incorrect options/alternatives of a step based on few initial key strokes, mouse clicks or voice response/answer of that step, dynamic generation of all or the more complex correct sub-expressions (such as ‘X+120°’) with or without a few incorrect sub-expressions in a step or all the steps of a full solution to simply click-and-integrate the correct series of sub-expressions in a particular step, drag and place the correct structural component/chemical ligand/reaction conditions for an organic compound, drag and place the correct physical action/reaction for visual assignment/assessment/exercise in physics and geography, drag and place the correct organic component/subsystem/action for visual assignment/assessment/exercise in biology. The target for the invention has been to create an online problem solving interface which receives complete or partial details of each step from the user which is quicker than the conventional pen and paper in solving most kind of assignments/assessments/exercises/problems in physics, chemistry, mathematics, geography, biology, information technology, languages, communications skills, personality development and general knowledge.

The invention greatly facilitates easier access and increasing integration of Information Technology in education by most extensively customizing the interface of the self-tutoring tools for interactive solutions to the class, subjects and topics and subtopics of the assignments/assessments/exercises to be done by the student. Thus, at one level, the interface for chemistry is different one from mathematics and the interface for organic chemistry is different from inorganic chemistry and within inorganic chemistry the interface for qualitative salt analysis is different from catalytic chemical reactions. Similarly, in mathematics the interfaces for Exponents for class V and class VII are different and the interfaces for finding HCF of numbers and geometry are different. In fact, the invention has build hundreds of interfaces so as to create dedicated interfaces for all topics and subtopics and even questions in subjects such as physics, chemistry, mathematics, geography, biology, information technology, languages, communication skills, personality development, and general knowledge to offer the significantly easy access to users to the tools.

The invention innovates user interfaces which overcome the input barriers—the necessary, extensive use of keyboard and mouse to input steps or solutions—and reach the revolutionary applications of Information Technology in self-tutoring and self-coaching.

The independent learning system is also seen as the pivot of the next generation of educational offering as reflected in the following:
A. multi-grade (or multi-age) classrooms around a chosen subject and topic
B. classrooms transactions to move away from overwhelmingly top-down, curricular, close-ended (chapter oriented) to overwhelmingly lateral, curricular and relevant co-curricular counseling and coaching, rather open-ended discussion, query and clarification
C. a new institutional framework (small batches of multi-grade students being facilitated by teacher entrepreneurs with intensive guidance and extensive co-curricular inputs) for K-12 education, at the least, wherein formal home schooling to become an effective and popular alternative with parents
D. enabling curricular and co-curricular inputs and tools for parents to most effectively and appropriately support their children emotionally and academically
E. enabling a educational revolution wherein enlisted mentor volunteers can support families and their children in curricular and co-curricular progress of such students through an innovative application of the 360° learning system which provides the most comprehensive window to the at the moment progress status of each student in niche as well as larger connected topics and subjects and the volunteers can support them through the system over the Internet (in ‘live’ or ‘later’ sessions)
F. enabling student and families to dynamically choose a peer group for every user student that most effectively supports and complements the user students
G. reducing role and need for supplementary education (no support beyond school and home)
H. reducing the cost of access to world-class education
I. most effectively universalizing and sustaining access to quality education

The present invention also provides an independent learning system which has a totally open-ended component (‘intelligent’) for instance homework testbed for junior classes, as well as a pre-defined component (‘non-intelligent’ and created through a ‘meta code’ for answers steps) for higher classes to address the widest range of assessments/assignments/exercises.

The independent learning system of the present invention is closest to the actual context of a student by organizing the educational content around the actual books used by the students or the broader curricular framework of the affiliating institutions of the schools of the students.

The present invention offers the widest range of response facility to the students such as answer only, jump steps, serialize random steps, minor modifications in steps as well click and select. The independent learning system is innovatively flexible and diverse to offer the most efficient and effective interface for usage by the students (a vast majority of the students are not comfortable with extensive use of keyboards for entering their answer steps); for instance, the system has multiple interfaces to best suit the type of question, multiple technology platform (e.g. Flash files, java scripts), in-step fragmented answers. The independent learning system is accessible over a wide range of devices using the Internet Protocol.

The present invention also provides a device based on the learning system wherein the device is any computing device, any Internet enabled device. The device has a special user interface enabling the user to select the type of educational content with such as but not limited to a single keystroke or via touchscreen or even audio instruction for a hands-free operation Various content types including text, audio/video streaming, animation are available to the user. The user downloads a file on to the device and then begin the interaction.

The user would have various means to respond such as but not limited to

(a) Select an option from multiple options by touchscreen or audio-based selection or typing in some keywords directly or from a quick access keywords/expressions or selecting a digit or alphabet e.g. a,bc,d or 1,2,3,4 corresponding to the options on the device screen. Such an interaction happens in the middle of a text, audio/video steaming session or at the end of the session.

(b) The device supports speech recognition the user has to select one of the options from a,b,c,d, he/she speaks the option into the device microphone and the same is communicated to the backend server, which activates the option. Such an interaction happens in the middle of a text, audio/video steaming session or at the end of the session.

The device works on various radio technologies such as but not limited to GSM, CDMA, W-CDMA, WiMax etc. Such a device is created using chipsets from various vendors like Texas Instruments, Qualcomm, Intel etc. For instance, a chipset with the capability of 6020 from Qualcomm would be capable of handling the basic requirements of such a device.

It creates a 360° educational context for each student by offering extensive windows to teachers, mentors, tutors, parents, chosen peers, chosen others of every student to view the progress of the student—live or later—and intervene appropriately in the development of the student.

The invention is described in detail with reference to the example given below which are provided to illustrate the invention and therefore, should not be construed to limit the scope of the invention.

### Example 1

The example is explaining the system used by a school.

A 360° learning system that could be integrated into a school's portal to virtually extend the school's resources and processes for a truly personalized learning context for each student within and outside the school. It also offers ‘standalone instructional content’ for students which effectively reduces the ‘curriculum completion pressure’ on teachers in the classrooms and reduces the critical dependence of academic attainments of students on teachers' academic credentials. The system offers online access to the institutional processes and resources at home and records all the inputs/interactions of the students and parents. These inputs and the reports and analysis generated therefrom can be seen by the teachers in the school.

The system provides for:

Digitalizing all processes and resources of the school—pre-class, in-class, post-class (including learning processes at home that has bearing on the curriculum in the school). This enablement essentially means that all text, visualisations, derivations, exercises used by an institution are converted into software so that they can be accessed in various formats over any digital display screens. The digitalisation also proceeds on its own by the 360° Learning System provider based on feedback and usage reports of the individual users too and the system generated reports and analysis.

Recording of each step or activity (clicks on the digital display screen and the keys on the keyboard or the voice-stimulated instructions) of the users especially the students in the use of the digital resources and showing it live or later in raw or intelligently diagnosed form to all the stakeholders concerned to dynamically recreate the learning processes and resources around each student to best complement the learning attainment, need and style of each student.

Specifically, but not at all limited to these instances, in math, all the homework assignments and other exercise problems in the prescribed text books of the school are offered on the school portal in such a way that the student actually ‘step-by-step’ solves them online on the portal. The platform offers the most appropriate interface for each assignment or exercise problem to nearly match the ‘paper and pen’ way of solving the same. The platform prompts the student with increasingly intelligent suggestions on each step to help reach the correct solution as taught to them by the teachers or the standard short-cuts. Of course, while the student solves the exercises or assignments, teachers, parents, principal or any other bonafide stakeholder such as classmates may view live or later the steps being taken by the students in solving each assignment or exercise.

The present invention also offers the unique ability of ‘online live homework testbed’ which enables users to feed their assignment or assessment questions into the system, not already in the bank of the system, and then solve the questions in fixed steps (without getting to see the right answer steps straight away) without any assistance or wait for a few hours (for the 360° learning system providers to feed the answer steps digitally into the ‘system backend’) and then solve the questions online without any live or direct human intervention for homework completion.

The system also creates a ‘drag & drop type’ playful visuals on the screen for the student wherein the ‘choices’ made by the students while playing with the visuals are recorded and diagnosed to create a ‘pattern’ of learnt and weak areas in the most ‘non-testing’ conditions.

The ‘live’ data thus generated creates the bedrock of the in-class transactions—the teacher exactly knows her/his deliverables before she enters the class and shift the focus of her/his attention the most appropriate set of students while discussing or revising a subject. This system helps in freeing the teacher of routine top-down lectures and indulge in more powerful, interesting, ‘less demanding’ and effective lateral discussions among students and intervene where necessary. She/he saves a lot of pre-class preparation time and important assessment chores—copy checking, student profile management, progress reporting etc. and use the same for more face to face interaction with students. In fact, she also saves a lot of time and increases attention on students in the classrooms by using ready to use comprehensive and customized instructional content instead of writing and drawing it herself/himself while in the class.

The administrators also get a unique window into the learning attainments of students and directly and focussedly handhold teachers with specific feedbacks on how they can improve the learning attainment of each student or a section or a class. This ability of the administrators helps without any prejudice to their own subject specialization and goes a long way in revolutionising educational administration. A principal with language specialisation can also counsel and advise a physics teacher on how to improve her classroom transaction or the students she teaches.

### Example 2

### Personal Learning Assistant

In this example, the device—akin to a mobile phone—has a special user interface enabling upto 85% screen area with just five operating keys and the extended keyboard available on on-screen virtual keyboard or the extended keyboard on the device. The user can select the type of educational content with a single keystroke. The device is intended to offer a minimal hands-on operation and quick back and forward capability and the audio with each learning module comes in two versions—one to go with the animations and the other on an standalone basis. Similarly, simple responses to questions can be SMSed to the server. The various content types including text, audio/video streaming, animation are available to the user. The user can also download a file on to the device and then begin the interaction. The user responds by selecting an option by touchscreen or keystrokes or even audio response (in the higher modules of the device). Such an interaction happens in the middle of a text, audio/video streaming session. The device can work in online or offline mode (with connectivity to the servers through SMS, when needed). The device can handle both the educational resources as well as the processes but it is optimized for the access and interactions of the educational resources.

Numerous modifications and adaptations of the system of the present invention will be apparent to those skilled in the art, and thus it is intended by the appended claims to cover all such modifications and adaptations which fall within the true spirit and scope of this invention.

1. A self-managed intelligent learning system operable only on a user after a threshold amount of clicks and choices on the system with the help of a device, said system further comprising self-tutoring-diagnostics with minimum text and maximum animated visualization; indirect or hidden diagnostic assessments; and an assignment checker.

2. The system as claimed in claim 1, wherein said device comprises a special user interface for enabling the user to provide inputs in form selected from the group consisting of a single keystroke, touchscreen, and audio instruction for a hands-free operation.

3. The system as claimed in claim 1, wherein said device comprises various content types selected from the group consisting of text, audio/video streaming, and animation.

4. The system as claimed in claim 1, wherein said device is adapted for working on various radio technologies selected from the group consisting of GSM, CDMA, W-CDMA, WiMax, bluetooth, Wi-Fi, and IEEE 802.11.

5. The system as claimed in claim 1, wherein said device is adapted for working on various wire line technologies selected from the group consisting of RS232, DOCSIS, interne, ethernet, http, tcp/ip, and www.

6. The system as claimed in claim 1, wherein said system is adapted for recording each step, showing a recorded step, in the form selected from the group consisting of live or later in raw or intelligently diagnosed form.

7. The system as claimed in claim 1, wherein said device is adapted to carry out analysis and assessment on the basis of choices made by the user, which are recorded and diagnosed and pattern of learnt and weak areas in the non-testing conditions are found.

8. The system as claimed in claim 1, wherein said device is provided with an authentication mechanism to verify immediate context of the student.

9. The system as claimed in claim 8, wherein said authentication mechanism is adapted to work on real identities established on the basis of relationships within an institutional setting.

10. The system as claimed in claim 1, wherein said system is adapted for non-geographical dependent e-learning, corporate management, geography independent government management, e-tutoring with the system analyzing and sending the assessment to the person.

11. The system as claimed in claim 1, wherein said device provides an interface for enabling the users to feed their assignment or assessment questions into the system, not already in the bank of the system, and then solve the questions in fixed steps.

12. The system as claimed in claim 1, wherein the input to said system is selected from a group consisting of touch, voice, key, and mouse for logging in.

13. The system as claimed in claim 1, wherein said system is compatible for working with any computing device selected from the group consisting of device connected to the internet, personal digital assistant, mobile phones, and laptops.

14. (canceled)
